(19) United States
(12) Patent Application Publication
(10) Pub. No.: US 2006/0143715 A1
(43) Pub. Date: Jun. 29, 2006

(54) Method and apparatus for providing security policy enforcement

(75) Inventors: Richard T. Chow, Santa Clara, CA (US); Alice L. Chu, Saratoga, CA (US); Sheshadri M. Iyengar, Cupertino, CA (US); Biju R. Kaimal, Emeryville, CA (US); Dmitri R. Latypov, San Mateo, CA (US); Samir R. Saxena, Mountain View, CA (US)

Correspondence Address: VEDDER PRICE KAUFMAN & KAMMHOLZ, 222 N. LASALLE STREET, CHICAGO, IL, 60601, US

(73) Assignee: Motorola, Inc., Schaumburg, IL (US)

(21) Appl. No.: 11/025,609

(22) Filed: Dec. 28, 2004

(51) Int. Cl. H04L 9/32

(52) U.S. Cl. 726/27

(57) ABSTRACT

A method and wireless mobile device invokes (802), under control of at least one of a plurality of applications, such as JAVA applications that run in a plurality of different execution environments, one or more common application interface (API), such as a JSR, that is common for use by the plurality of applications. The method and wireless mobile device also invoke (804) a zone permission check, in response to the invocation of the common API, that determines which execution environment a calling application is in, in response to zone identification data associated with each call in a group of calls in a call stack for the shared API. Once the environment is determined, a security permission check is invoked in a determined execution environment for the calling application to check permissions associated with the calling application.

### FIELD OF THE INVENTION

The present invention relates generally to the field of apparatus and methods for providing security policy enforcement and more particularly to methods and apparatus for providing security policy enforcement for mobile wireless devices.

### BACKGROUND OF THE INVENTION

Computing devices and other devices may have different capabilities and features based on the applications installed in their memory. Firmware and applications may be pre-installed to a computing device before purchase by a customer or installed after purchase by a customer or service technician via a storage media, such as a magnetic or optical disk. For computing devices that communicate with a computer network, applications may be installed after a customer or service technician downloads the applications to the computing device.

Wireless mobile devices, such as cell phones, PDA's or any other suitable wireless mobile devices may utilize JAVA applications or may be compliant with various standards and may be for example J2ME compliant devices. Such devices have security managers which enforce security policies which are a type of rule or rules to ensure that various security constrains are maintained within the device. One security policy may be that only certain applications supplied by certain authors or sources can invoke an SMS messaging. Numerous other security policies are also known and enforced by the security policy manager. In addition, certain mobile device platforms may use defined JAVA specification requests (JSR) which are standard sets of API's defined for a particular mobile device operational platform. One JAVA specification for mobile devices is a J2ME compliant device that employs mobile information device profiles (MIDP). MIDlets are JAVA applications that run in a MIDP environment. An execution environment uses a defined set of API's that are defined for that particular execution environment. Therefore a MIDP environment is an environment that uses a defined set of JSR's and other API's. Typically, a single device uses a single execution environment. Where a wireless mobile device utilizes two or more JAVA execution environments, there may be different security models employed by the different execution environments.

A problem can arise for example where two different applications that run in each of the two different execution environments calls a common API or set of API'S. A security operation would need to confirm that all calls in a chain are permitted by the calling application. However, when two different applications from two different execution environments are calling the same API, multiple security models may be used, one for each of the different execution environments. The device needs to be able to determine which execution environment or zone the calling application came from in order to determine which security policy to enforce.

Therefore, a need exists for a different apparatus and method for providing security policy enforcement in a mobile wireless device that employs two or more execution environments.

### BRIEF DESCRIPTION OF THE DRAWINGS

FIG. 1 is a schematic view illustrating an embodiment of a wireless communication system in accordance with the present invention.

FIG. 2 is a schematic view illustrating another embodiment of the wireless communication system in accordance with the present invention.

FIG. 3 is a block diagram illustrating exemplary internal components of various servers, controllers and devices that may utilize the present invention.

FIG. 4 is a block diagram representing the functional layers of a client device in accordance with the present invention.

FIG. 5 is a block diagram illustrating an embodiment of the functional layers of the client device in accordance with the present invention.

FIG. 6 is a block diagram illustrating another embodiment of the lower level functional layers of the client device in accordance with the present invention.

FIG. 7 is a block diagram illustrating one example of a wireless mobile device that provides security policy enforcement in accordance with one embodiment of the invention.

FIG. 8 is a flowchart illustrating one example of a method for providing security policy enforcement on a wireless mobile device in accordance with one embodiment of the invention.

FIG. 9 is a flowchart illustrating one example of a method for providing security policy enforcement on a wireless mobile device in accordance with one embodiment of the invention.

### DETAILED DESCRIPTION OF THE PREFERRED EMBODIMENTS

Briefly, a method and wireless mobile device invokes, under control of at least one of a plurality of applications, such as JAVA applications that run in a plurality of different execution environments, one or more common application interface (API), such as a JSR, that is common for use by the plurality of applications. The method and wireless mobile device also invoke a zone permission check, in response to the invocation of the common API, that determines which execution environment a calling application is in, in response to zone identification data associated with each call in a group of calls in a call stack for the shared API. Once the environment is determined, a security permission check is invoked in a determined execution environment for the calling application to check permissions associated with the calling application. In one embodiment this includes calling an appropriate security manager that is responsible for a given execution environment.

As a result, a wireless mobile device may be able to accommodate multiple execution environments while still maintaining proper security policy enforcement when applications associated with different execution environments utilize common API's that are common to both execution environments. Other advantages will be recognized by those of ordinary skill in the art.

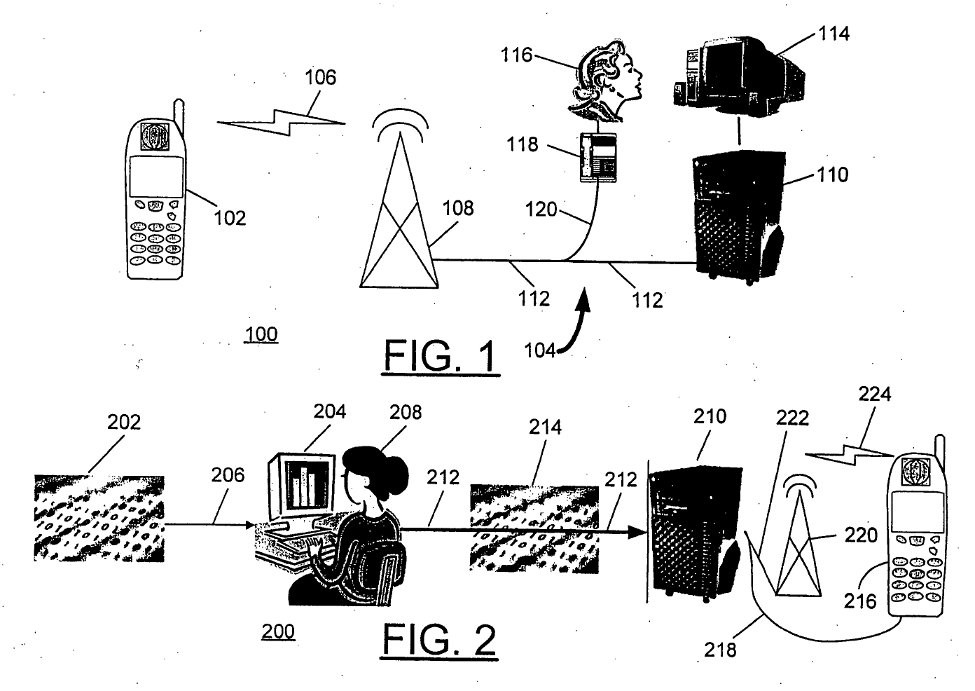

Referring to FIG. 1, there is provided a schematic view illustrating an embodiment of a wireless communication system 100. The wireless communication system 100 includes a wireless communication device 102 communicating with a wireless communication network 104 through a wireless link 106. Any type of wireless link 106 may be utilized for the present invention, but it is to be understood that a high speed wireless data connection is preferred. For example, the wireless communication network 104 may communicate with a plurality of wireless communication devices, including the wireless communication device 102, via a cellular-based communication infrastructure that utilizes a cellular-based communication protocols such as AMPS, CDMA, TDMA, GSM, iDEN, GPRS, EDGE, UMTS, WCDMA and their variants. The wireless communication network 104 may also communicate with the plurality of wireless communication devices via a peer-to-peer or ad hoc system utilizing appropriate communication protocols such as Bluetooth, IEEE 802.11, IEEE 802.16, and the like.

The wireless communication network 104 may include a variety of components for proper operation and communication with the wireless communication device 102. For example, for the cellular-based communication infrastructure shown in FIG. 1, the wireless communication network 104 includes at least one base station 108 and a server 110. Although a variety of components may be coupled between one or more base stations 108 and the server 110, the base station and server shown in FIG. 1 is connected by a single wired line 112 to simplify this example.

The server 110 is capable of providing services requested by the wireless communication device 102. For example, a user of the device 102 may send a request for assistance, in the form of a data signal (such as text messaging), to the wireless communication network 106, which directs the data signal to the server 110. In response, the server 110 may interrogate the device and/or network state and identify one or more solutions. For those solutions that require change or correction of a programmable module of the device 102, the server 110 may send update data to the device via the wireless link 106 so that the programmable module may be updated to fulfill the request. If multiple solutions are available, then the server 110 may send these options to the device 102 and await a response from the device before proceeding.

The wireless communication system 100 may also include an operator terminal 114, managed by a service person 116, which controls the server 110 and communicates with the device 102 through the server. When the server 110 receives the request for assistance, the service person may interrogate the device and/or network state to identify solution(s) and/or select the best solution if multiple solutions are available. The service person 116 may also correspond with the device 102 via data signals (such as text messaging) to explain any issues, solutions and/or other issues that may be of interest the user of the device.

The wireless communication system 100 may further include a voice communication device 118 connected to the rest of the wireless communication network 104 via a wired or wireless connection, such as wired line 118, and is available for use by the service person 116. The voice communication device 118 may also connect to the network via the server 110 or the operator terminal 114. Thus, in reference to the above examples, a user of the device 102 may send a request for assistance, in the form of a voice signal, to the wireless communication network 106, which directs the data signal to the server 110. While the server 110 and or the service person 116 is interrogating the device and/or network state, identifying one or more solutions, and/or selecting an appropriate solution, the service person may correspond with the device 102 via voice signals to explain any issues, solutions and/or other issues that may be of interest the user of the device.

Referring to FIG. 2, there is provided a schematic view illustrating another embodiment of the wireless communication system. For this embodiment, operator requirements 202 are received by a service terminal 204 via a first connection 206 and a service person 208 operates the service terminal 204, if necessary. For example, the service person 208 may provide information about a desired operator and/or needs of a device user so that the appropriate operator requirements 202 are received. The service terminal 204 may optionally be connected to a server 210 by a second connection 212. Regardless of whether the server 210 is used, the service terminal 204 generates appropriate components that should be sent to a wireless communication device 216 operated by the user in accordance with the operator requirements 202 and associated information. The device 216 may be coupled to the service terminal 204 or the server 210 via a wired connection 218, such as a cable or cradle connection to the device's external connector, or a wireless connection. The wireless connection may include a wireless communication network that includes a base station 220 connected to the service terminal 204 or the server 210 and a wireless link 224 communication with the device 216.

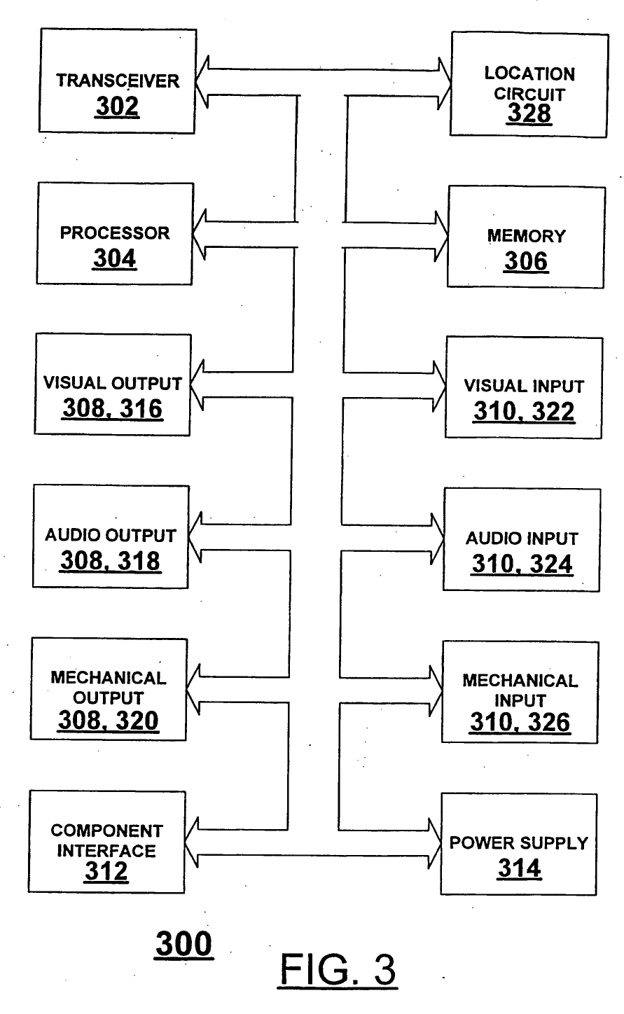

Referring to FIG. 3, there is provided a block diagram illustrating exemplary internal components of various servers, controllers and devices that may utilize the present invention, such as the wireless communication devices 102, 316 and the servers 110, 310 of FIGS. 1 and 2. The exemplary embodiment includes one or more transceivers 302, a processor 304, a memory portion 306, one or more output devices 308, and one or more input devices 310. Each embodiment may include a user interface that comprises at least one input device 310 and may include one or more output devices 308. Each transceiver 302 may be a wired transceiver, such as an Ethernet connection, or a wireless connection such as an RF transceiver. The internal components 300 may further include a component interface 312 to provide a direct connection to auxiliary components or accessories for additional or enhanced functionality. The internal components 300 preferably include a power supply 314, such as a battery, for providing power to the other internal components while enabling the server, controller and/or device to be portable.

Referring to the wireless communication devices 102, 316 and the servers 110, 310 of FIGS. 1 and 2, each machine may have a different set of internal components. Each server 110, 310 may include a transceiver 302, a processor 304, a memory 306 and a power supply 314 but may optionally include the other internal components 300 shown in FIG. 2. The memory 306 of the servers 110, 310 should include high capacity storage in order to handle large volumes of media content. Each wireless communication device 102, 316 must include a transceiver 302, a processor 304, a memory 306, one or more output devices 308, one or more input devices 310 and a power supply 314. Due to the mobile nature of the wireless communication devices 102, 316, the transceiver 302 should be wireless and the power supply should be portable, such as a battery. The component interface 312 is an optional component of the wireless communication devices 102, 316.

The input and output devices 308, 310 of the internal components 300 may include a variety of visual, audio and/or mechanical outputs. For example, the output device(s) 308 may include a visual output device 316 such as a liquid crystal display and light emitting diode indicator, an audio output device 318 such as a speaker, alarm and/or buzzer, and/or a mechanical output device 320 such as a vibrating mechanism. Likewise, by example, the input devices 310 may include a visual input device 322 such as an optical sensor (for example, a camera), an audio input device 324 such as a microphone, and a mechanical input device 326 such as a flip sensor, keyboard, keypad, selection button, touch pad, touch screen, capacitive sensor, motion sensor, and switch.

The internal components 300 may include a location circuit 328. Examples of the location circuit 328 include, but are not limited to, a Global Positioning System (GPS) receiver, a triangulation receiver, an accelerometer, a gyroscope, or any other information collecting device that may identify a current location of the device.

The memory portion 306 of the internal components 300 may be used by the processor 304 to store and retrieve data. The data that may be stored by the memory portion 306 include, but is not limited to, operating systems, applications, and data. Each operating system includes executable code that controls basic functions of the communication device, such as interaction among the components of the internal components 300, communication with external devices via the transceiver 302 and/or the component interface 312, and storage and retrieval of applications and data to and from the memory portion 306. Each application includes executable code utilizes an operating system to provide more specific functionality for the communication device, such as file system service and handling of protected and unprotected data stored in the memory portion 306. Data is non-executable code or information that may be referenced and/or manipulated by an operating system or application for performing functions of the communication device.

The processor 304 may perform various operations to store, manipulate and retrieve information in the memory portion 306. Each component of the internal components 300 is not limited to a single component but represents functions that may be performed by a single component or multiple cooperative components, such as a central processing unit operating in conjunction with a digital signal processor and one or more input/output processors. Likewise, two or more components of the internal components 300 may be combined or integrated so long as the functions of these components may be performed by the communication device.

In accordance with the present invention, an expansion of known frameworks for more suitability to a wireless device operability is disclosed herein. FIG. 4, illustrates a basis architecture of a mobile device in accordance with the present invention. Existing known mobile devices are typically architected such that applications are loaded on top of a fixed base platform. APIs for applications are fixed at manufacture. Therefore it is not possible to postpone, for example, new media types and/or other upgrades. Turning to FIG. 4, a mobile device of the present invention utilizes an open OS, such as for example, Linux or Windows. Additionally, a modem interface is abstracted such that it is agnostic to the particular interface, for example radio interfaces such as GSM, CDMA, UMTS, etc. that would traditionally utilize dedicated functionality.

Referring to FIG. 4, there is provided a block diagram generally representing functional layers 400 included in the memory portion 306 (shown in FIG. 3) of a client device, such as the wireless communication device 102, 216. The functional layers 400 include low-level layers 402 including a modem layer 404 and an operating system layer 406, a mid-level layer 408 also known as a framework layer 410, and high-level layers 412 including a user interface layer 414 and a services layer 416. The modem layer 404 may be an abstracted interface to a modem circuit of the client device in which services are accessed through message passing. The modem layer 404 may be air-interface agnostic, i.e., may operate using a wide variety of air interface protocols. The modem layer 404 may also be an abstracted interface to an RTOS, and executive application programming interfaces (API's) may be encapsulated in a thin interface layer. Further, the modem code may be on a separate processor or co-resident with application code.

The operating system layer 406 operates above the modem layer 404 and provides basic platform services for the client device, such as process management, memory management, persistent storage (file system), Internet networking (TCP/IP), and native access security and application-to-application protection. The operating system layer 406 may expose native services based upon standards-defined API's (POSIX). The operating system layer 406 may host native applications, such as system daemons, specific-language interpreters (such as JAVA), and second-party native applications (such as a browser). Daemons are executable code that run as separate background processes and provide services to other executable code(s) or monitor conditions in the client device.

The framework layer 410 provides an operable interface between the low-level layers 402 and the high level layers 412 that provides ample opportunities for current and future functions and, yet, is efficient enough to avoid provide unnecessary code that may waste precious memory space and/or slow-down the processing power of the client device. Key features of the framework layer 410 may include, but are not limited to, hierarchical class loaders, application security, access to native services, and compilation technology for performance. Although the operating system layer 406 may host system daemons and specific-language interpreters, the framework layer 410 should actually include such system daemons and specific-language interpreters. The framework layer 410 may also include a framework for managing a variety of services and applications for the client device. For one embodiment, the framework layer 410 is an always-on CDC/FP/PBP JVM, OSGi framework.

The services layer 416 adapts the framework layer 410 to wireless communication services. The services layer 416 includes services packaged in modular units that are separately life-cycle managed (e.g., start, stop, suspend, pause, resume); are separately provisioned, upgraded and withdrawn; and abstracts the complexity of the service implementation from a user of the client device. Services are modular, extensible and postponeable so that, within the services layer 416, services may be added, upgraded and removed dynamically. In particular, the services layer 416 includes a lookup mechanism so that services may discover each other and applications may discover services used by other services, e.g., service provider interfaces (SPI's), and services used by applications, e.g., application programming interfaces (API's).

An API is a formalized set of function and/or method calls provided by a service for use by a client device, whereas an SPI is a set of interfaces and/or methods implemented by a delegated object (also called provider) providing an API to the client device. If an API is offering methods to client devices, more API's may be added. Extending the functionality to offer more functionality to client devices will not hurt them. The client device will not use API's that are not needed. On the other hand, the same is not true for SPI's. For SPI's, the addition of a new method into an interface that others must provide effectively breaks all existing implementations.

The user interface layer 414 manages applications and the user interface for the client device. The user interface layer 414 includes lightweight applications for coordinating user interaction among the underlying services of the services layer 416. Also, the user interface layer 414 is capable of managing native applications and language-specific application, such as JAVA. The user interface layer 414 creates a unifying environment for the native applications and the language-specific applications so that both types of applications have a similar “look and feel”. The native applications utilize components of a native toolkit, and the language-specific applications utilized components of a corresponding language-specific toolkit. For the user interface layer 414, a language-specific user interface toolkit is built on the native toolkit, and MIDlets are mapped to the language-specific user interface toolkit.

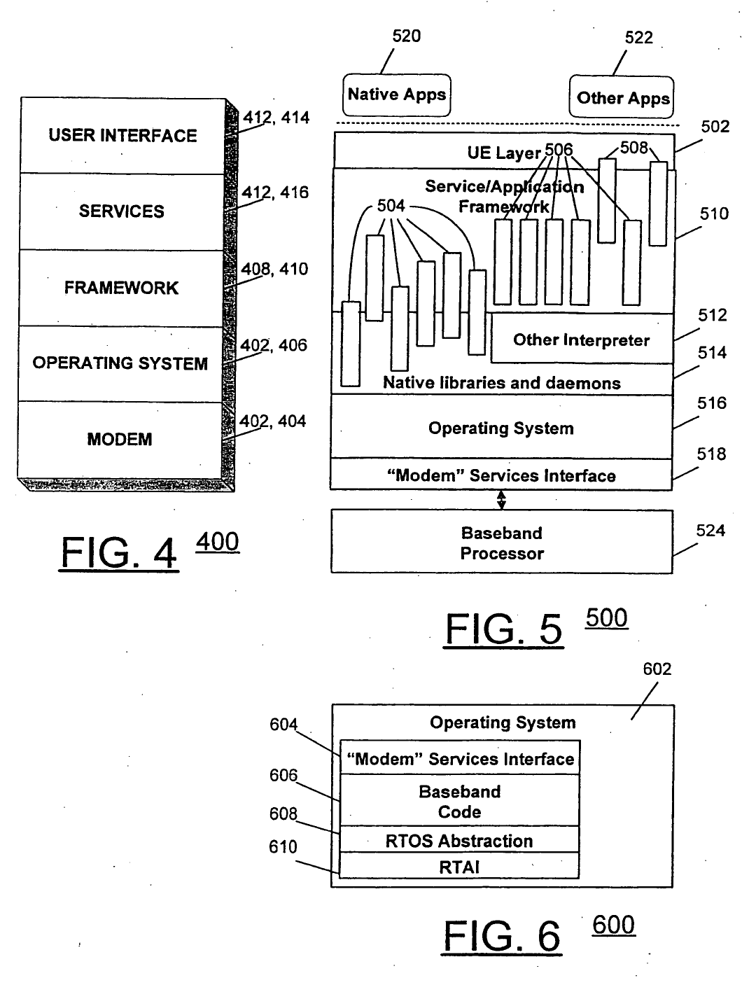

FIG. 5 illustrates details of a mobile device architecture, having dual processors, in accordance with some embodiments of the present invention. In FIG. 5 a Service/Application Framework provides services such as but not limited to; messaging, security, DRM, device management, persistence, synchronization, and power management. An abstracted modem service interface communicates with the baseband processor, wherein the baseband processor may communicate over any suitable radio interface. In FIG. 5, the UE Layer, may be implemented for example in Java. The Operating System is an open operating system and may utilize for example Linux or Windows.

Unlike prior art architectures, as previously mentioned, wherein applications are loaded on top of a fixed base platform, applications as shown in the embodiments illustrated by FIG. 5 are architected in a more flexible structure. In accordance with the embodiments of FIG. 5, application and feature upgrades, new content types, new standards-based upgrades, new operator specific service libraries, and component upgrade and repair are facilitated.

Referring to FIG. 5, there is provided a block diagram illustrating a first client embodiment 500 included in the memory portion 306 of the client device, such as the wireless communication device 102, 216. The first client embodiment 500 includes a UE layer 502, a plurality of services 504, 506, 508, a service/application framework 510, an other or language-specific interpreter 512 (such as JAVA Virtual Machine), native libraries and daemons 514, an operating system 516, and a modem services interface 518. The UE layer 502 interacts with native applications 520 and language-specific applications 522, such as JAVA. The modem services interface interacts 518 with a baseband processor 524 of the client device.

The applications are user-initiated executable code whose lifecycle (start, stop, suspend, pause, resume) may be managed. The applications may present a User Interface and/or may use services. Each daemon is an operating system (OS) initiated, executable code that runs as a separate background process. Daemons may provide services to other executable code or monitor conditions in the client.

There is organizational cooperation of the services 504, 506, 508 with the mid-level layer 408 which includes the service/application framework 510, the language-specific interpreter 512 and the native libraries and daemons 514 as well as the UE layer 502. As represented by FIG. 5, the types of available services include native-based services 504 which rely on one or more components of the native libraries and daemons 514, language-specific services 506 which rely on components associated with the language-specific interpreter 512, and native or language-specific services 508 that further rely on components of the UE layer 502.

A service is a set of functionality exposed via a well-defined API and shared among applications. A service has as least two characteristics, namely a service interface and a service object. The service interface is the specification of the service's public methods. The service object implements the service interface and provides the functionality described in the interface. A service may provide methods that present a User Interface. Invoking a method on a service is done in the caller's context (thread/stack). Services may return a value to the requesting client by depositing it on the caller's stack, unlike an invoked application. The implementation of the service may be replaced without affecting its interface Examples of services include, but are not limited to, messaging, security, digital rights management (DRM), device management, persistence, synchronization and power management.

A system service is a low-level service specific to an operating system or MA and is not part of the abstract set of services exposed to platform components. System service APIs should not be used by any component that is intended to portable across all instantiations of the platform. A framework service is a service that exposes a higher level abstraction over system services and provides OS-independent and MA-independent access to infrastructure components and services. An application service is a service that exposes application-specific functionality (both UI and non-UI) via a well defined API. A native service is a service written in native code.

A library is a set of services contained in an object that can either be statically linked or dynamically loaded into executable code. Library services may invoke other library services or services contained in daemons, which are external to the library and may also run in a different process context.

Referring to FIG. 6, there is provided a block diagram illustrating a second client embodiment 600 of the lower level functional layers of the client device. The first client embodiment 500 represents a dual processor architecture of a client device, whereas the second client embodiment 600 represents a single core architecture of a client device. For the second client embodiment 600, the operating system 602 includes the modem services interface 604 and a baseband code 606. In addition, the operating system 602 may include other components, such as an RTOS abstraction 608 and an RTAI 610.

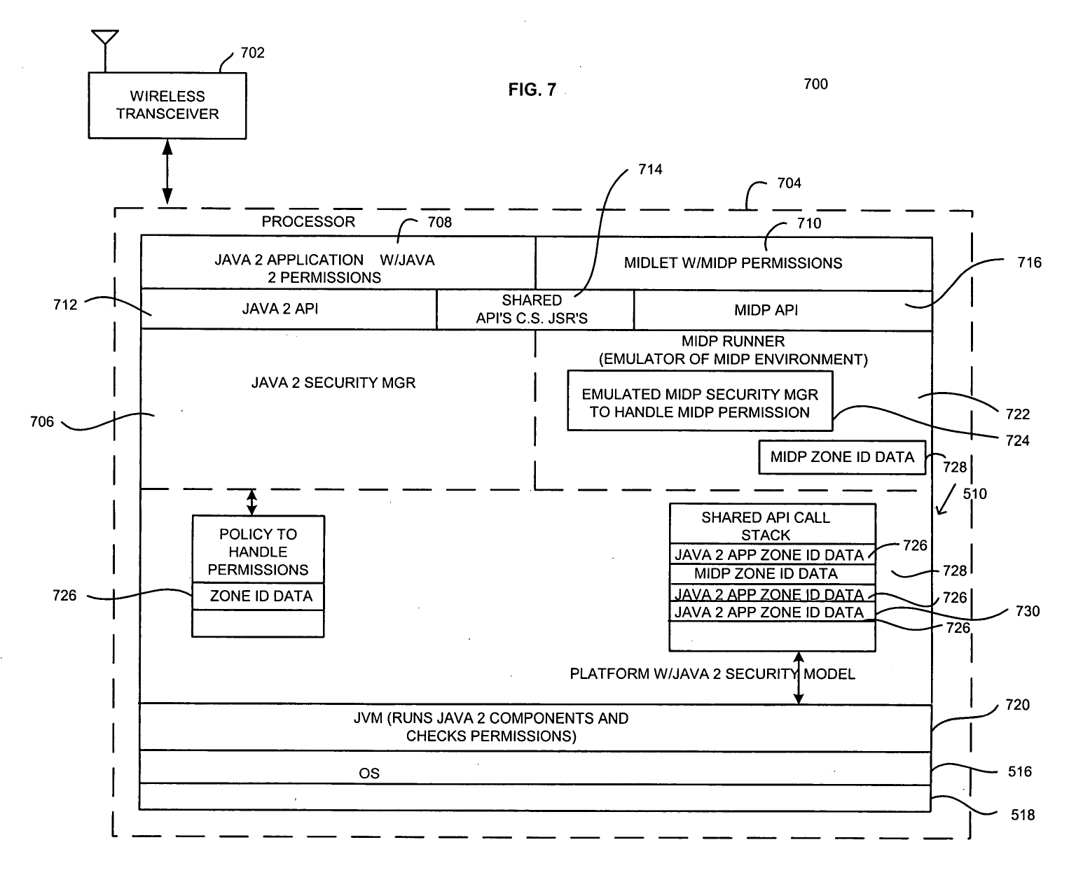

FIG. 7 is a block diagram of one example of a wireless communication device such as a wireless mobile device 700 that includes suitable memory 306 for storing application code and operating system code in the form of executable instructions that when executed by one or more processors performs the functions as described herein. The wireless mobile device 700 includes a conventional wireless transceiver 702 for wirelessly sending and receiving information to another wireless device or network element either directly or through a suitable network as described earlier. In addition, the wireless mobile device includes a processor 704 which may be any suitable structure (including multiple processors) which is suitably programmed to carry out the operations described below.

For example, the processor 704 may include numerous software modules stored in memory which cause the processor to operate as described below. As shown, the processor may employ an operating system 516 such as a Linux operating system or any other suitable operating system, and platform code 510 which may include a JAVA 2 virtual machine (JVM) which as known in the art runs JAVA 2 components and as further described herein additionally performs zone permission checks as well as known operations. The platform described in this particular example is shown to have a JAVA 2 security model and corresponding JAVA 2 security manager 706.

The wireless mobile device 700 in this example provides two different execution environments, a JAVA 2 execution environment and a MIDlet execution environment. JAVA 2 application(s) 708 have associated JAVA 2 permissions whereas MIDlets 710 have their own associated MIDP permissions. The wireless mobile device 704 also contains JAVA 2 virtual machine (JVM) 720.

The processor 704 also employs JAVA 2 API's 712, one or more shared API's 714 which as used here it also includes sets of shared API's, such as JSR's, and MIDP API's 716 that are used by MIDlet application 710. Similarly, the JAVA 2 API's 712 are used in conjunction with the JAVA 2 application 708. The platform code 510 which includes in this example the JAVA 2 virtual machine (JVM) 720, also includes a MIDP runner 722 which includes an emulated MIDP security manager 724 to handle MIDP permissions. The MIDP runner is code that complies with the JAVA 2 security model and which serves as an emulator of a MIDP environment. All of the platform code (e.g. apps) other than the MIDP runner 722 is assigned a common zone permission that is represented as zone identification data 726 wherein the MIDP runner (i.e. an application) is assigned a different zone permission shown as zone identification data 728. The platform 510 also includes a shared API call stack 730 which maintains a list of calls from an application from the platform that is calling a shared API 714. The shared API call stack 730 may be stored in any suitable memory as desired.

JSR implementations such as JSR 120, JSR 135 and others are typically available to MIDlets. Using these API's, MIDlets, for example, can send or receive SMS messages. JSR's are also available to JAVA 2 application 708 and as such are shown to be shared API's 714. However, since MIDP environments and JAVA 2 environments may implement different security models, JSR API's which implement access control, using check permissions, for example, need to operate appropriately in a given zone or execution environment. A security model inclues a definition of the privileges in the environment, data defining a method for giving applications these privileges, and a method for enforcing these privileges. It would be desirable if they were not aware of the fact that they were being called by MIDlets or JAVA 2 applications. Given the multiple execution environments, such as the code necessary to fully implement the JAVA 2 applications and the code necessary to implement the MIDlet applications, the platform code 510 needs to invoke the proper time and level of security permissions depending upon where the JSR API's execute.

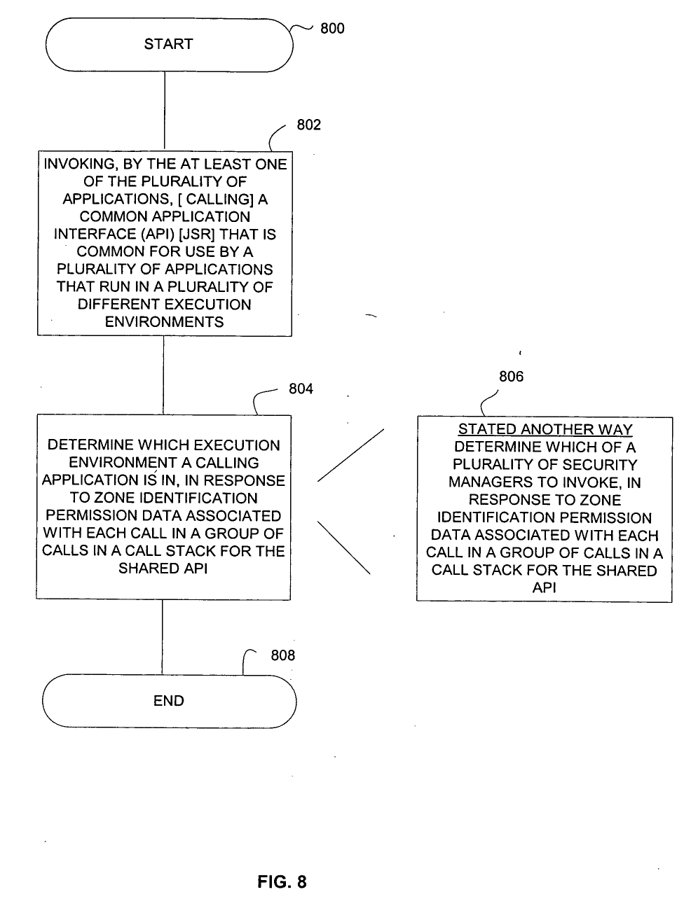

FIG. 8 is a flowchart illustrating one example of a method for providing security policy enforcement on a wireless device such as 700 in accordance with one example. As shown in block 800, the method may begin for example by the user or other processor running either a JAVA 2 application 708, or a MIDlet application 710 or both. As shown in block 802, the method includes invoking, under control of at least one of the plurality of applications, such as the JAVA 2 application 708 or the MIDlet application 710, a common application interface 714 that is common for use by both the JAVA 2 application 708 and the MIDlet application 710. These applications run in a plurality of different execution environments, which is a set of code necessary to fully implement the respective of applications. It will be understood that the different execution environments may utilize some common code but not all of the code is common

As shown in block 804, the method includes invoking a zone permission check, such as by the JAVA 2 security manager 706 in response to the invocation, or call from the common API, wherein the permission check determines which execution environment the calling application is in. This determination is done in response to evaluating zone identification data that is assigned or associated to the code that calls the shared API. In this example, all platform code 510 is assigned the same zone ID data 726 so that all of the platform code to execute the applications that makes the calls is assigned the same zone ID data. The zone ID data is a zone permission that is assigned to code that calls API's on behalf of the JAVA 2 application for example. Although the MIDP runner 722 is also an application within the platform 510, it is assigned a different zone identifier and is referred to MIDP zone ID data 728 so that each time the MIDP runner 722 calls a shared API 714 on behalf of a MIDlet 710, the MIDP zone identification data 728 is placed in the shared API call stack 730. Likewise, each time the JAVA 2 platform code 510 makes a call to the shared API call stack 730 on behalf of a JAVA 2 application 708, the zone ID data 726 is stored in the shared API call stack. The shared API call stack 730 stores a group of calls representative of the applications that have called the particular shared API.

As shown in block 804, the zone permission check determines which execution environment a calling application is in by analyzing the zone identification data in the shared API call stack 730. As shown in this example, since there are three calls by a JAVA 2 application (since the zone ID data 726 appears in the shared API call stack), but a MIDP zone ID 728 also appears in the group of calls in the shared API call stack 730, the processor determines that a MIDlet as calling the shared API and as such the emulated MIDP security manager 726 is invoked to carry out security permission checks, as known in the art, for the particular MIDlet application to enforce the security policies associated with the MIDP security model.

However, if instead all of the zone ID data in the shared API call stack 730 (e.g. zone ID data 726) is associated with the zone ID data 726, then the processor 704 determines that a JAVA 2 application 708 is the calling application. Essentially, the processor 704 examines the shared API call stack to see that all zone ID data is of type zone ID data 726. As a result the JAVA 2 security manager 706 is then invoked by the platform 510 to enforce the security policy permissions of the JAVA 2 security model.

As noted above each of the execution environments employs a different security model and in this example a JAVA 2 security model is used by JAVA 2 applications whereas MIDlet applications employ a MIDP security model via the emulated MIDP security manager.

In this example, the shared API 714 is a JSR that performs access control functions such as allowing the application 708 or 710 to access an SMS operation to allow the application to invoke SMS messaging. However, it will be recognized that any shared API may be used.

Since the zone ID data in the shared API call stack identifies which of the plurality of differing security managers are employed, the method includes invoking a respective security permission check that is carried out by the security manager 706, thereafter selectively calling a security manager API wherein the security manager API's are each associated with a different executing environment

As shown in block 806, stated another way, the method includes determining which of a plurality of security managers to invoke in response to the zone identification permission data associated with each call in a group of calls in the call stack for the shared API. As shown in block 808, the method may include finalizing the shared API call stack for another group of calls to determine if another application requires selection of the appropriate security policy.

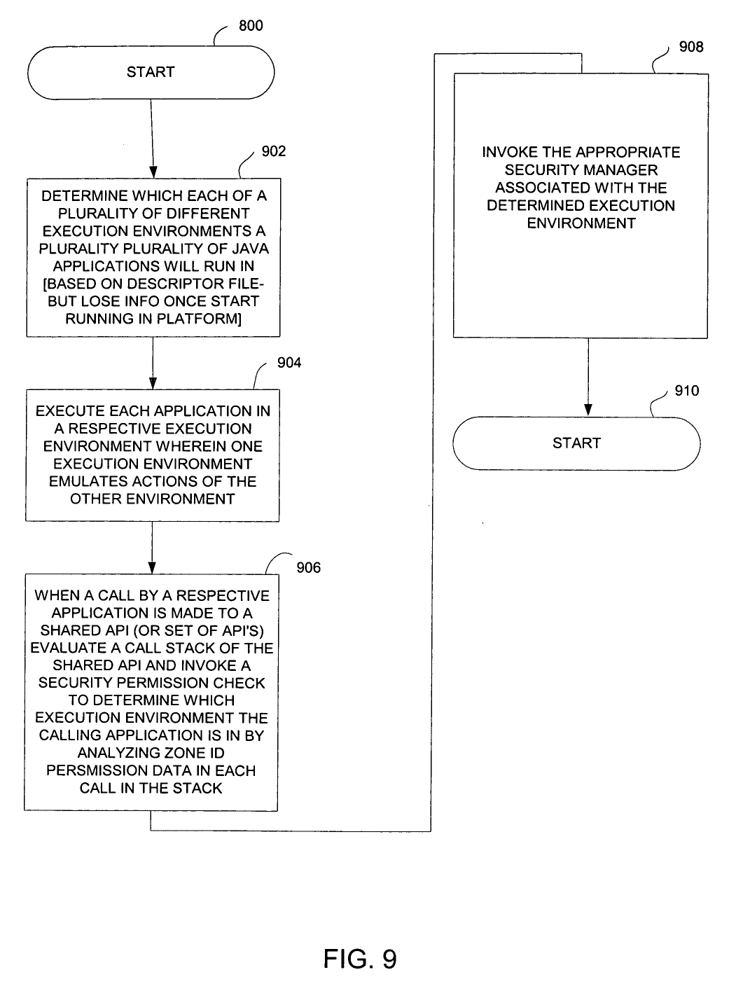

FIG. 9 is a method for providing security policy enforcement on a wireless mobile device in accordance with one embodiment of the invention. As shown in block 902, the method may include prior to invoking the common API 714, first determining which of a plurality of different execution environments one of the plurality of applications 708 and 710 is running in. For example, prior to the calling of the shared API 714, an application such as either the JAVA 2 application 708 or the MIDlet application 710 may already have descriptor information associated therewith so that the processor at least initially knows which environment the application is in so that it can suitably invoke either the MIDP runner or the JAVA 2 platform code to begin running of the application. As such, determining which of the plurality of different execution environments that a particular application is running in may be based on, for example, reviewing a descriptor file and then invoking the appropriate platform code or MIDP runner to begin execution of the particular application. Other ways of determining which zone or execution environment the application needs to run in may also be used, including but not limited to evaluating a digital signature information or basing the detection on storage located in the application or any other suitable mechanism.

Also, the platform code 510 is a platform application and the MIDP runner may also be considered another platform application that operates as platform code and emulates and execution environment such as a MIDP environment, in this particular example. However, it will be recognized that any suitable environment may be emulated and alternatively that different execution environments may be employed where one of the environments is not emulated.

As shown in block 904, once the execution environment is known, the method includes executing each application in its respective execution environment. In this example, one execution environment, namely the MIDP runner 722, emulates actions of another environment, but is written to be, in this example, compliant with the JAVA 2 security model. As such, the MIDP security manager 724 is an emulated MIDP security manager and enforces MIDP security policies.

As shown in block 906 and is described for example with respect to FIGS. 7 and 8, the method includes when a call by a respective application is made to a shared API, evaluating a call stack of a shared API and invoking a security permission check and determining which execution environment the calling application is in by analyzing the zone ID permission data identified in the call stack. As shown in block 908, the method also includes invoking the appropriate security manager 724 or 706 associated with the determined execution environment that the calling application is in. As shown in block 910, the method may include, again repeating the process or evaluating shared API call stacks to determine which zone other applications are in that are accessing the shared API.

The security managers look up the policy associated with the piece of code that has been determined to be accessing the shared API's to verify that it has JSR permission. As such, a special JAVA 2 permission (i.e. the zone identification data) is employed for use in the shared API call stack to an environment of an application that is accessing a common API. In the above embodiment, MIDP applications are executed by a MIDP emulator or simulator of a MIDP environment and an application that is a MIDP application is actually managed in some respects as a JAVA 2 application.

The methods and apparatus allow use of multiple execution environments that allow the sharing of API's which may be useful in many applications since programmers may be familiar with certain JSR's or shared API's to allow improved program development and implementation. In addition, the methods and apparatus provide for a flexible system that can run different applications that are designed for different executing environments. Other advantages will be recognized by those of ordinary skill in the art.

The below TABLE I represents code executed by the processor to perform the zone permission checking operations as noted above. The operations described below are carried out by the shared API's 714 (JSR code) and 706 (Java 2 Security Manager).

Table I

/**
* JSR code
*/
sendSMS( )
{

SMSPermission smsperm = new SMSPermission( );
AccessController.checkJSRPermission(

“javax.microedition.io.connector.sms”, smsperm);
}
/**
* Use in JSR code instead of normal checkPermission
*
* @param midpPerm MIDP style permission that MIDlet needs
* @param java2Perm Java 2 Permission that JUIXlet needs
*/
void checkJSRPermission(String midpPerm, Permission java2Perm)
throws
SecurityException
{

if (isMIDlet( ))
{

// call MIDP runner to do MIDlet-style permission
checking
MIDP.checkPermission(midpPerm) ;

}

else

AccessController.checkPermission(java2Perm) ;

}
/**
* If the MIDP runner is on the stack, will return true
boolean isMIDlet( )
{

jsrPerm jsrperm = new jsrPerm(“juix”);
try
{
AccessController.checkPermission (perm) ;
}
catch(AccessControlException e)
{

return true;

}
return false;

}

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for providing security policy enforcement on a wireless mobile device comprising:
invoking, under control of at least one of a plurality of applications, a common application interface (API) that is common for use by a plurality of applications that run in a plurality of different execution environments; and
invoking a zone permission check, in response to the invocation of the common API, that determines which execution environment a calling application is in, in response to zone identification data associated with each call in a group of calls in a call stack for the shared API.

2. The method of claim 1 wherein each of the plurality of different execution environments uses a set of API's that share the common API and wherein each of the plurality of different execution environments employs a different security model, which comprises a definition of the privileges in the environment, a method for giving applications these privileges, and a method for enforcing these privileges.

3. The method of claim 1 including invoking a respective security permission check associated with a determined one of the plurality execution environments to check permissions associated with the calling application.

4. The method of claim 1 wherein the common API performs an access control function for the invoking application.

5. The method of claim 3 wherein invoking a respective security permission check includes selectively calling one of a plurality of security manager API's, each associated with a different of the plurality of executing environments, based on the determined execution environment of the application.

6. The method of claim 1 including prior to invoking the common API, the method includes determining which of a plurality of different execution environments at least one the plurality of applications is running.

7. The method of claim 1 wherein the plurality of execution environments are defined by a first platform application and a second platform application that emulates an execution environment.

8. A method for providing security policy enforcement on a wireless mobile device comprising:
invoking, under control of at least one of a plurality of JAVA applications, a common application interface (API) that is common for use by a plurality of JAVA applications that run in a plurality of different execution environments that share a common security model and wherein one of the execution environments is an emulated execution environment;
invoking a zone permission check, in response to the invocation of the common API, that determines which execution environment a calling application is in, in response to zone identification data associated with each call in a group of calls in a call stack for the shared API; and
invoking a respective security permission check associated with a determined one of the plurality execution environments to check permissions associated with the calling.

9. The method of claim 8 wherein each of the plurality of different execution environments uses a set of API's that share the common API and wherein each of the plurality of different execution environments employs a different security model

10. The method of claim 9 wherein the common API performs an access control function for the invoking application.

11. The method of claim 8 wherein invoking a respective security permission check includes selectively calling one of a plurality of security manager API's, each associated with a different of the plurality of executing environments, based on the determined execution environment of the application.

12. The method of claim 111 including prior to invoking the common API, the method includes determining which of a plurality of different execution environments at least one the plurality of applications is running in.

13. The method of claim 8 wherein the plurality of execution environments are defined by a first platform application and a second platform application that emulates an execution environment.

14. A wireless mobile device comprising:
a wireless transceiver;
a processor operatively coupled to the wireless transceiver and operative to execute programming instructions that when executed cause the processor to:
invoke a common application interface (API) that is common for use by a plurality of applications that run in a plurality of different execution environments; and
invoke a zone permission, in response to the invocation of the common API, that determines which execution environment a calling application is in, in response to zone identification data associated with each call in a group of calls in a call stack for the shared API.

15. The wireless mobile device of claim 14 wherein the processor is operative to employ the plurality of different execution environments to use a set of API's that share the common API and wherein each of the plurality of different execution environments employs a different security model

16. The wireless mobile device of claim 14 wherein the processor is operative to invoke a respective security permission check associated with a determined one of the plurality execution environments to check permissions associated with the calling application.

17. The wireless mobile device of claim 14 wherein the processor is operative to performs an access control function for the invoking application under control of the common API.

18. The wireless mobile device of claim 14 wherein the processor is operative to electively call one of a plurality of security manager API's, each associated with a different of the plurality of executing environments, based on the determined execution environment of the application.

19. The wireless mobile device of claim 14 wherein the processor is operative to, prior to invoking the common API, determine which of a plurality of different execution environments at least one the plurality of applications is running in.

20. The wireless mobile device of claim 14 wherein the plurality of execution environments are defined by a first platform application and a second platform application that emulates an execution environment.
